(19) United States
(12) Patent Application Publication
(10) Pub. No.: US 2016/0054443 A1
(43) Pub. Date: Feb. 25, 2016

(54) COLLISION PREVENTION SYSTEM FOR GROUND SUPPORT EQUIPMENT

(71) Applicant: MALLAGHAN ENGINEERING LIMITED, Dungannon, County Tyrone (GB)

(72) Inventor: Ronan Mallaghan, Dungannon, County Tyrone (GB)

(21) Appl. No.: 14/781,213

(22) PCT Filed: Mar. 28, 2014
(86) PCT No.: PCT/EP2014/056271

§ 371 Date: Sep. 29, 2015

(30) Foreign Application Priority Data
Mar. 29, 2013 (GB) 1305834.2

(51) Int. Cl. G01S 13/93; G08G 1/16; G08G 5/06; G08G 5/04

(52) U.S. Cl. CPC G01S 13/931; G08G 5/04; G08G 1/16; G08G 5/06; G01S 2013/9353; G01S 2013/9335

(57) ABSTRACT

A collision prevention system for ground support equipment, said system comprising means for identifying an aircraft in the vicinity of the ground support equipment and for determining a virtual model of the aircraft based upon stored data and said identification of the aircraft, the system further comprising means for determining parameters relating to the location, speed and orientation of the ground support equipment relative to the aircraft and comparing said parameters to said virtual model to prevent collisions between the ground support equipment and the aircraft.

This invention relates to a collision prevention system for ground support equipment and in particular to a collision prevention system for preventing collisions between Ground Support Equipment (GSE) and aircraft.

The term GSE as used herein is intended to cover cabin service vehicles (e.g. catering trucks, cleaning trucks), passenger loading vehicles (passenger stairs, PRM [Passengers with Reduced Mobility] vehicle), cargo/baggage loading vehicles (belt loader, lower deck loader), and lavatory/water service vehicles.

The EU is facing a major crisis in airport capacity. If no action is taken, by 2025 more than sixty major European airports will be severely overcrowded. In order to address this threat, the EU has implemented a wide ranging action plan that encompasses legislation, financial support, the promotion of co-ordinated planning, and technology development. These measures are likely to increase airport productivity; turnaround times will be reduced, and more passengers will be delivered to their destinations. This is likely to put ever greater strains on the ground handling crews responsible for turnaround operations. Even without any increase in airport capacity, air transport accidents on the apron are already above the all industry average and injuries to workers at UK airports increased by 50% between 2002 and 2008.

Additionally, operating under time constraints in highly congested areas and quite often in difficult weather conditions in relative darkness, these workers are damaging the highly engineered aircraft they are servicing. Even a minor accident involving an aircraft can result in an airline having to cancel all scheduled flights for that aircraft, leading to lost ticket revenue, additional costs for passenger's lodgings, payment for accident investigation, repair of damage, etc.

According to one international airline, [symbol] 54 million in direct damage to their aircraft from ramp operations resulted in approximately [symbol] 380 million in lost income. The direct cost of ground accidents to aircraft amounts to approximately [symbol] 5 billion annually and a staggering five times that figure in indirect costs. Of this figure, [symbol] 1 billion is directly attributable to accidents caused by GSE. As more aircraft manufactured from composite materials come into service, these costs are likely to rise even more dramatically as damage analysis and repairs become more time-consuming. Even more worrying is that safety will be compromised. Impacts on composite aircraft can cause unnoticeable internal damage that can severely reduce structural strength and stability.

Existing state-of-the-art technologies fail for a number of reasons. Firstly, the very latest sensing technologies from the automobile industry are all application-specific sensors and offer very little functionality, meaning many sensors are required for all round collision detection. In the chaotic environment of an airport apron, the number of sensors needed is likely to be even higher. Secondly, some of these sensors do not react well to the convex surfaces typically found on aircraft. Thirdly, many of the sensor types are just not robust enough and lose accuracy when dirty, or when operating in unfavourable weather conditions. Finally, close range docking to aircraft is a challenging and complex operation for the GSE operator, often carried out in difficult conditions. No current technology is yet capable of delivering an adequate solution to the GSE operator's needs.

To overcome the limitations of currently available technology, it is an object of the present invention project to provide a novel solution to address the problem of collisions involving GSE and aircraft.

According to a first aspect of the present invention there is provided a collision prevention system for ground support equipment, said system comprising means for identifying an aircraft in the vicinity of the ground support equipment and for determining a virtual model of the aircraft based upon stored data and said identification of the aircraft, the system further comprising means for determining parameters relating to the location, speed and orientation of the ground support equipment relative to the aircraft and comparing said parameters to said virtual model to prevent collisions between the ground support equipment and the aircraft.

Preferably said system comprising processing means for determining said virtual model of the aircraft and for determining at least one virtual anti-collision envelope around the aircraft, the system being adapted to control the movement of the ground support equipment to prevent intrusion of the ground support equipment into said anti-collision envelope. For example, such control could be to apply the brakes of the ground support equipment to limit the speed or arrest the equipment if the system determines that it will enter the anti-collision envelope upon its current course.

Preferably said means for determining parameters relating to the location, speed and orientation of the ground support equipment provides real time data acquisition representing the location, speed and orientation of the ground support equipment with respect to the aircraft.

In one embodiment said means for identifying the aircraft comprises a receiver unit for receiving aircraft identification data transmitted from the aircraft. In alternative embodiment the means for identifying the aircraft includes an operator interface enabling the operator to input information to facilitate identification of the aircraft. Said aircraft identification means may be adapted to communicate with airport systems to identify the aircraft based upon the information provided by the operator, such as aircraft identification numbers or other marking or flight number.

Preferably the system comprises a memory device programmed with reference data to enable the processing means to generate said virtual model of the aircraft once the make and model of the aircraft has been identified.

In one embodiment said means for determining said parameters of the location, speed and orientation of the ground support equipment with respect to the aircraft comprises a radar based system, such as synthetic aperture, Frequency Modulated Continuous Wave (FMCW) or Doppler radar, preferably at around 77 GHz. Said parameter determining means may further comprise an inertial navigation system, using accelerometers and/or gyroscopes, for continuously tracking the speed, position and orientation of the ground support equipment with respect to the aircraft.

Said radar based system may be used to periodically recalibrate the parameters determined by the inertial navigation system.

Suitable sensors may be provided on moveable parts of the ground support equipment such that a continuously updated model of the shape of the ground support equipment can be generated and compared with the virtual model of the aircraft to ensure that the ground support equipment is not moved into a position wherein a collision with the aircraft may occur.

Preferably the system is provided with a graphical user interface to provide the operator of the ground support equipment with a graphical representation of the position and orientation of the ground support equipment with respect to the aircraft.

The system may be adapted to control the speed of the ground support equipment to prevent intrusion of the ground support equipment into said anti-collision envelope.

According to a further aspect of the present invention there is provided a collision prevention method for ground support equipment comprising the steps of identifying an aircraft in the vicinity of the ground support vehicle, generating a virtual model of the identified aircraft and determining a virtual anti-collision envelope around the aircraft; determining and tracking the location, speed and orientation of the ground support equipment with respect to the aircraft, and controlling the motion of the ground support equipment to prevent the vehicle from entering said anti-collision envelope.

An advantage of the system in accordance with the present invention is that the fact that the make and model of the aircraft being serviced is known, and therefore all of its dimensions are known. Therefore, by identifying the position of the ground support equipment (GSE) in relation to this known stationary aircraft at a given point in time, then from that point onwards, the position of the GSE can be tracked in relation to this aircraft. By knowing the position and orientation of the GSE at all times, it will then be possible to assist the operator during operations, and if necessary, control the vehicle to prevent collisions.

A collision prevention system for ground support equipment in accordance with an embodiment of the present invention will now be described, by way of example only, with reference to the accompanying drawings, in which:

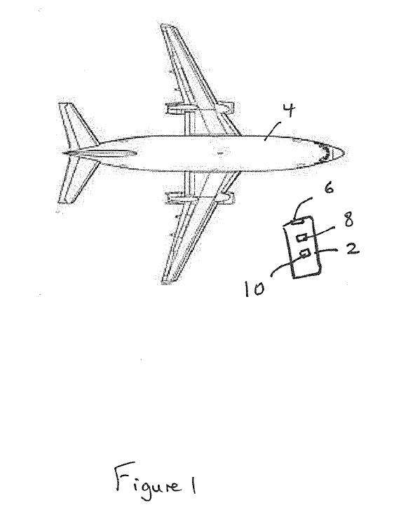

FIG. 1 is a schematic illustration of ground support equipment incorporating a collision prevention system in accordance with an embodiment of the present invention; and

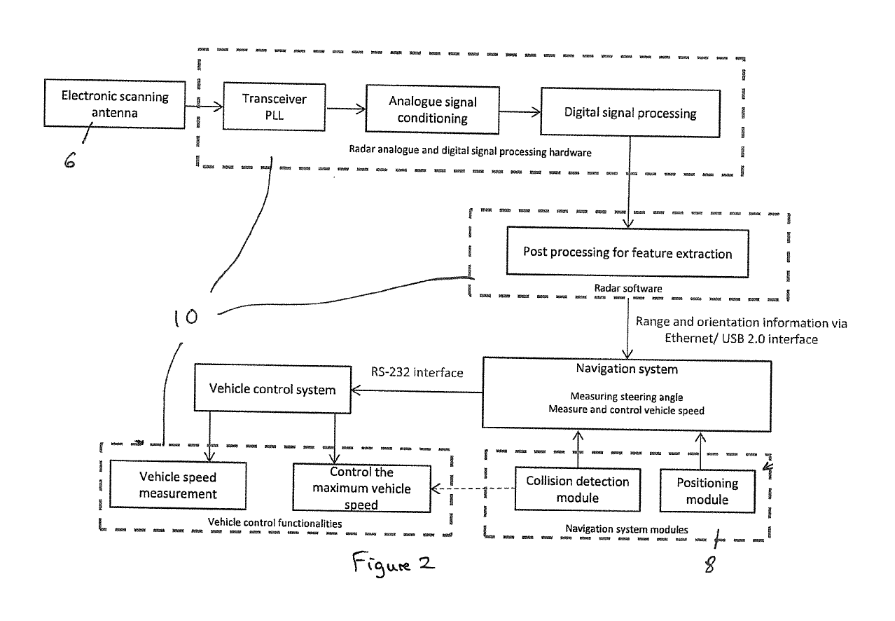

FIG. 2 is a schematic diagram of the collision prevention system of FIG. 1.

As illustrated in FIG. 1, an item of Ground Support Equipment (GSE) 2, such as a cabin service vehicle (e.g. catering truck, cleaning truck), passenger loading vehicle (passenger stairs, PRM vehicle), cargo/baggage loading vehicle (belt loader, lower deck loader), or lavatory/water service vehicle, may be required to approach an aircraft 4 in order perform numerous tasks when the aircraft is parked on the apron at an airport.

In order to prevent collisions between the GSE 2 and the aircraft 4, the GSE is fitted with a collision prevention system in accordance with an embodiment of the present invention, comprising a radar device 6 for the detection of range and orientation of the GSE from the aircraft; an inertial navigation system (INS) 8 for continuously track the GSE position and orientation in relation to the aircraft; and a processing unit 10 for generating a virtual model of the aircraft and generating a anti-collision envelope around the aircraft, the system controlling the speed of the GSE, based upon the position and orientation data generated by the radar device 6 and INS 8, to prevent the GSE from entering the anti-collision envelope. The radar device 6 may comprise a 77 GHz synthetic aperture, Frequency Modulated Continuous Wave (FMCW) or Doppler radar, for the detection of range and orientation of the GSE from the aircraft. The INS 8, based on accelerometers and gyroscopes, enables positional tracking of the GSE, enabling the system to map the exact position of the GSE with respect to the virtual model of the aircraft at all times. The radar device 6 may be used to periodically recalibrate the INS 8.

The system may be adapted to automatically control the movement of the GSE, for example by controlling the brakes and/or drive means of the GSE to limit or control the speed of the GSE to prevent the GSE from entering into an anti-collision envelope determined around the virtual model of the aircraft. Variable speed limits may be set within the system for controlling the maximum speed of the GSE in the vicinity of the aircraft.

The system may include one or more of the following further features:

1. Means for identification of the make and model of the aircraft to be serviced by the GSE. This may comprise an operator interface wherein the user may input information, such as aircraft identification numbers or other markings, or flight number, to facilitate identification of the aircraft. The system may include flight data or may communicate with other airport systems such that information provided by the operator can be used to identify the aircraft. Alternatively, the operator interface may include a menu system allowing the user to identify the make and model of the aircraft. In an alternative embodiment, information may be received from the aircraft to enable identification of the make and model of the aircraft (e.g. ADS-B). Once the aircraft has been identified, the system can select appropriate stored data to generate a virtual model of the aircraft within the processing unit 10 of the system. This model may enable the system to determine the dimensions of the aircraft for use in a GSE collision avoidance application.

2. Sensors may be provided on the GSE, preferably cloud point sensor nodes, for detecting and displaying changes in shape and configuration of the working parts of the GSE, in particular during aircraft docking operations.

3. The system may incorporate a graphical user interface (GUI) for assisting the operator of the GSE, preferably providing an accurate graphical representation of the position of the GSE with respect to the aircraft.

The operation of the system will now be described in more detail below.

Once the aircraft has been identified, via selection by the operator or aircraft identification information provided by the operator and/or by information received directly from the aircraft and/or airport systems, a virtual model of the aircraft can be generated by the system based upon stored reference data. The system can then instruct the collision avoidance program to conform to the exact features and dimensions of that aircraft.

The radar device 6, for example synthetic aperture, Frequency Modulated Continuous Wave (FMCW) or Doppler radar, may utilise feature extraction in order to determine the orientation and position of the GSE in relation to aircraft, particularly upon the initial approach of the GSE towards the aircraft. The radar device 6 may be mounted on the front of the GSE and is able to rapidly precisely sense the body of the aircraft. The range and feature information received by the radar device 6 may be then mapped to the features of the aircraft virtual model stored on the processing unit of the system. From this, an exact position and orientation (P&O) of the GSE versus the aircraft can be generated. All this can all be done without interruption the GSE's normal apron operations. With the P&O determined, a navigation/tracking system may be required.

The inertial navigation system (INS) 8 may continuously track the GSE position and orientation in relation to the aircraft. The INS 8 may be fitted on board the GSE and can provide P&O tracking information.

The INS 8 may incorporate low-cost MEMS accelerometers/gyroscopes that can continuously calculate, via dead reckoning, the position, orientation, and velocity of the GSE, without the need for external references. It is possible that the accuracy can be improved, if required, by the use of a low cost global positioning system (GPS). Orientation and position information determined by the radar device 6 may be used to periodically recalibrate the parameters determined by the INS.

When the GSE 2 has reached its final position near the target aircraft 4, it may be required to perform the docking operation with the aircraft, for example to communicate a conveying device into a luggage hold or to move a stairway, ramp or platform into contact with an opening or doorway of the aircraft. During such docking operation, the shape of the GSE 2 will be changing in close proximity to the aircraft.

In one embodiment, in order to both assist the GSE operator, and detect/avoid any possible collisions, the shape of the GSE 2 may be continuously monitored by suitable sensors. A parametric model of the GSE may be used to build a 3D virtual model of the GSE, using inputs from wireless or wired sensor nodes or a field bus, preferably with wireless interface, placed at key points on the GSE. Such system may be used to facilitate manual docking and/or to enable automated docking operations to be carried out by the system.

The GUI may be specifically designed to meet the requirements of an operator/driver working in a dynamic environment with many distractions. A concise user friendly display may be provided to allow the GSE driver to view their vehicle in relation to the parts of the aircraft that are in closest proximity and therefore most at risk.

It is envisioned that the GUI may have a primary screen mode, e.g. a ‘driving mode,’ and optionally a secondary screen mode, e.g. a ‘docking mode.’

The combination of the aforementioned systems can deliver an innovative, cost effective, retrofitable, robust aircraft collision avoidance system for GSE.

The system in accordance with the invention will have the ability to map the movement of a GSE in relation to an aircraft, whereby any part of the GSE in relation to said aircraft is known. Using this information the system is able to prevent collisions between GSE and the aircraft.

There follows a detailed twelve step system operation description of a collision prevention system in accordance with an embodiment of the present invention.

1. The GSE 2 is driven towards the aircraft 4 that is to be serviced. The operator inputs information into the system via the operator interface to enable the system to identify the aircraft, preferably using information provided by airport systems. Alternatively the system may receive aircraft identification information directly from the aircraft. This enables the system to generate a virtual model of the aircraft from stored reference data.

2. When within a radial zone of 30 m from the aircraft, detected by the radar the system ‘locks-on’ to the aircraft. ‘Lock-on’ is when the exact location of GSE is identified (location is range, orientation, and elevation of the aircraft in relation to the GSE). From the point of ‘lock on’, the following may occur:
a. The operator of the GSE is notified that ‘lock-on’ has occurred through audio alert and the GUI.
b. A speed limit, or a variable speed limit regime, may be engaged for limiting the maximum speed of the GSE.
c. A virtual anti-collision envelope is created around the aircraft.
d. The Inertial Navigation System 8 begins tracking the location of the vehicle in relation to the aircraft.
e. During tracking, 3D parametric representations of the aircraft and GSE are computer simulated in relation to each other.
f. The radar device 6 continually or intermittently counter-checks the location of GSE in relation to aircraft, recalibrating the INS 8 as necessary.

3. The operator continues to move the GSE 2 towards the aircraft 4 until a docking position has been reached, at which point the operator stops the GSE. During this stage the system is monitoring speed in relation to distance from the aircraft. If the GSE is not within acceptable system limits, then the system may automatically decelerate the GSE to meet those limits, and if necessary the GSE will be brought to a complete stop, for example by automatic application of the brakes.

4. As the GSE is now stationary, the driver may select ‘docking mode’.

5. Docking mode is where the equipment on the GSE, such as a luggage conveyor or passenger steps, is manoeuvred into very close proximity with the aircraft.

6. Docking can either be carried out manually by the operator with assistance from audio alerts and information displayed on the GUI, or optionally the system may be adapted to enable automated docking.

7. The GSE remains in the ‘docked’ position until operations on the aircraft are complete.

8. When operations are complete, the equipment is withdrawn. No positive movement of the GSE vehicle towards the aircraft is permitted by the system during this operation.

9. When the equipment is fully withdrawn, ‘docking mode’ is automatically disengaged.

10. The operator reverses the GSE away from the aircraft. The INS on the GSE continues to track the position and orientation of the GSE in relation to all parts of the aircraft. The radar continually counter-checks these parameters. During this stage the system is monitoring speed in relation to distance from the aircraft. If the GSE is not within acceptable system limits (either variable or fixed speed limits determined by the system), then the GSE may be automatically decelerated to meet those limits, and if necessary the GSE may be brought to a complete stop.

11. The GSE is driven away from the aircraft that has been serviced.

12. When outside a radial zone of 30 m from the aircraft lock-on mode and the speed limit disengages.

The system may incorporate test modes, requiring the operator to carry out test routines, such as a brake test, at certain times. The system may disable the GE if such test routines are not completed or if a fault is detected.

The invention is not limited to the embodiment(s) described herein but can be amended or modified without departing from the scope of the present invention.

1. A collision prevention system for ground support equipment, said system comprising an apparatus for identifying an aircraft in the vicinity of the ground support equipment and for determining a virtual model of the aircraft based upon stored data and said identification of the aircraft, the system further comprising a sub-system for determining parameters relating to the location, speed and orientation of the ground support equipment relative to the aircraft and comparing said parameters to said virtual model to prevent collisions between the ground support equipment and the aircraft.

2. A system as claimed in claim 1, further comprising a processing device for determining said virtual model of the aircraft and for determining at least one virtual anti-collision envelope around the aircraft, the system being adapted to control the movement of the ground support equipment to prevent intrusion of the ground support equipment into said anti-collision envelope.

3. A system as claimed in claim 1, wherein said sub-system for determining parameters relating to the location, speed and orientation of the ground support equipment provides real time data acquisition representing the location, speed and orientation of the ground support equipment with respect to the aircraft.

4. A system as claimed in claim 1, wherein said apparatus for identifying the aircraft comprises a receiver unit for receiving aircraft identification data transmitted from the aircraft.

5. A system as claimed in claim 1, wherein the apparatus for identifying the aircraft includes an operator interface enabling the operator to input information to facilitate identification of the aircraft.

6. A system as claimed in claim 5, wherein said aircraft identification apparatus is adapted to communicate with airport systems to identify the aircraft based upon the information provided by the operator, such as aircraft identification numbers or other marking or flight number.

7. A system as claimed in claim 1, wherein the system comprises a memory device programmed with reference data to enable the processing device to generate said virtual model of the aircraft once the make and model of the aircraft has been identified.

8. A system as claimed in claim 1, wherein said sub-system for determining said parameters of the location, speed and orientation of the ground support equipment with respect to the aircraft comprises a radar based system.

9. A system as claimed in claim 8, wherein said sub-system for determining said parameters of the location, speed and orientation of the ground support equipment with respect to the aircraft comprises synthetic aperture, Frequency Modulated Continuous Wave (FMCW) or Doppler radar.

10. A system as claimed in claim 8, wherein said sub-system for determining said parameters of the location, speed and orientation of the ground support equipment with respect to the aircraft further comprises an inertial navigation system, having accelerometers and/or gyroscopes, for continuously tracking the speed, position and orientation of the ground support equipment with respect to the aircraft.

11. A system as claimed in claim 10, wherein said radar based system is operable to periodically recalibrate the parameters determined by the inertial navigation system.

12. A system as claimed in claim 1, further comprising sensors provided on moveable parts of the ground support equipment, wherein said sensors are operable to generate and compare a continuously updated model of the shape of the ground support equipment with the virtual model of the aircraft to ensure that the ground support equipment is not moved into a position wherein a collision with the aircraft may occur.

13. A system as claimed in claim 1, wherein the system is provided with a graphical user interface to provide the operator of the ground support equipment with a graphical representation of the position and orientation of the ground support equipment with respect to the aircraft.

14. A system as claimed in claim 1, wherein the system is adapted to control or limit the speed of the ground support equipment to prevent intrusion of the ground support equipment into said anti-collision envelope.

15. A collision prevention method for ground support equipment comprising the steps of identifying an aircraft in the vicinity of the ground support vehicle, generating a virtual model of the identified aircraft and determining a virtual anti-collision envelope around the aircraft; determining and tracking the location, speed and orientation of the ground support equipment with respect to the aircraft, and controlling the motion of the ground support equipment to prevent the vehicle from entering said anti-collision envelope.

16. A method as claimed in claim 15, comprising the steps of providing sensors on moveable parts of the ground support equipment and generating a continuously updated model of the shape of the ground support equipment and comparing said model with the virtual model of the aircraft to ensure that the ground support equipment is not moved into a position wherein a collision with the aircraft may occur.
